(19) United States
(12) Patent Application Publication
(10) Pub. No.: US 2015/0161437 A1
(43) Pub. Date: Jun. 11, 2015

(54) IMAGE PROCESSOR COMPRISING GESTURE RECOGNITION SYSTEM WITH COMPUTATIONALLY-EFFICIENT STATIC HAND POSE RECOGNITION

(71) Applicants: Ivan L. Mazurenko, Moscow (RU); Dmitry N. Babin, Moscow (RU); Alexander A. Petyushko, Moscow (RU); Denis V. Parfenov, Moscow (RU); Pavel A. Aliseychik, Moscow (RU); Alexander B. Kholodenko, Moscow (RU)

(72) Inventors: Ivan L. Mazurenko, Moscow (RU); Dmitry N. Babin, Moscow (RU); Alexander A. Petyushko, Moscow (RU); Denis V. Parfenov, Moscow (RU); Pavel A. Aliseychik, Moscow (RU); Alexander B. Kholodenko, Moscow (RU)

(21) Appl. No.: 14/358,320

(22) PCT Filed: May 1, 2014
(86) PCT No.: PCT/US14/36339

§ 371 Date: May 15, 2014

(30) Foreign Application Priority Data
Oct. 30, 2013 (RU) 2013148582

(51) Int. Cl. G06K 9/00

(52) U.S. Cl. CPC G06K 9/00389

(57) ABSTRACT

An image processing system comprises an image processor having image processing circuitry and an associated memory. The image processor is configured to implement a gesture recognition system comprising a static pose recognition module. The static pose recognition module is configured to identify a hand region of interest in at least one image, to perform a skeletonization operation on the hand region of interest, to determine a main direction of the hand region of interest utilizing a result of the skeletonization operation, to perform a scanning operation on the hand region of interest utilizing the determined main direction to estimate a plurality of hand features that are substantially invariant to hand orientation, and to recognize a static pose of the hand region of interest based on the estimated hand features.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor having image processing circuitry and an associated memory. The image processor is configured to implement a gesture recognition system comprising a static pose recognition module. The static pose recognition module is configured to identify a hand region of interest in at least one image, to perform a skeletonization operation on the hand region of interest, to determine a main direction of the hand region of interest utilizing a result of the skeletonization operation, to perform a scanning operation on the hand region of interest utilizing the determined main direction to estimate a plurality of hand features that are substantially invariant to hand orientation, and to recognize a static pose of the hand region of interest based on the estimated hand features.

By way of example only, performing a scanning operation utilizing the determined main direction may comprise determining a plurality of lines perpendicular to a line of the main direction, and scanning the hand region of interest along the perpendicular lines.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing a static pose recognition module in an illustrative embodiment.

FIG. 2 is a flow diagram of an exemplary static pose recognition process performed by the static pose recognition module in the image processor of FIG. 1.

FIG. 3 is a flow diagram showing a more detailed view of a process for determining a main direction of a hand region of interest in one of the steps of the FIG. 2 process.

FIGS. 4, 5 and 6 illustrate the estimation of hand features utilizing the main direction determined by the process of FIG. 3.

### DETAILED DESCRIPTION

Embodiments of the invention will be illustrated herein in conjunction with exemplary image processing systems that include image processors or other types of processing devices configured to perform gesture recognition. It should be understood, however, that embodiments of the invention are more generally applicable to any image processing system or associated device or technique that involves recognizing static poses in one or more images.

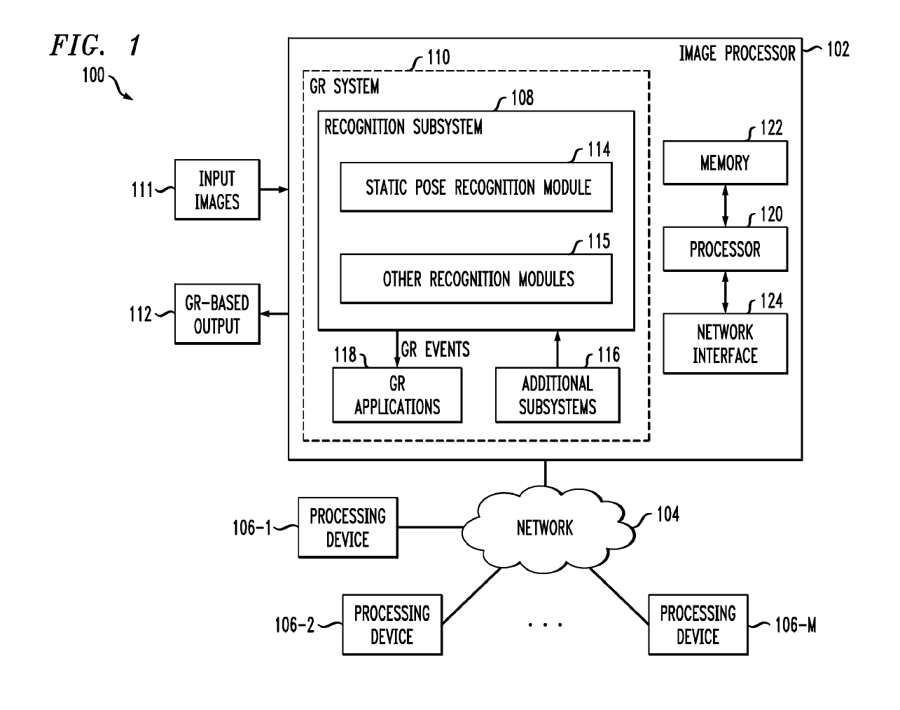

FIG. 1 shows an image processing system 100 in an embodiment of the invention. The image processing system 100 comprises an image processor 102 that is configured for communication over a network 104 with a plurality of processing devices 106-1, 106-2, . . . 106-M. The image processor 102 implements a recognition subsystem 108 within a gesture recognition (GR) system 110. The GR system 110 in this embodiment processes input images 111 from one or more image sources and provides corresponding GR-based output 112. The GR-based output 112 may be supplied to one or more of the processing devices 106 or to other system components not specifically illustrated in this diagram.

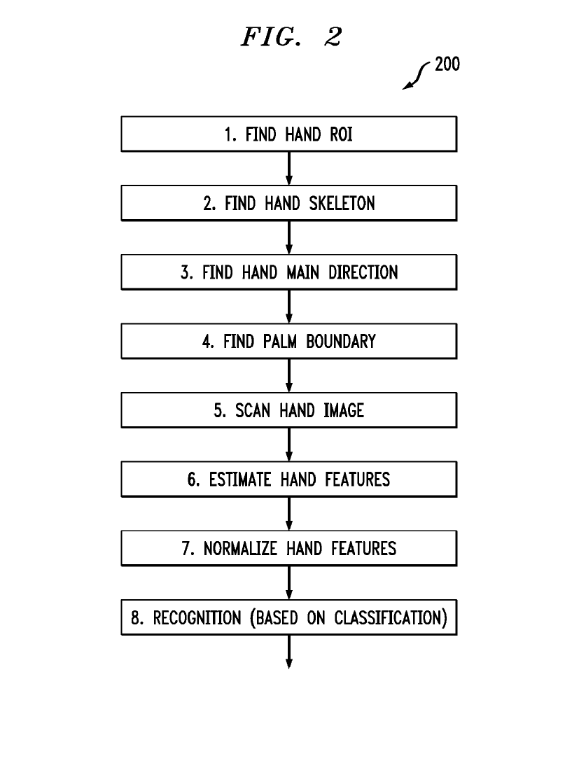

The recognition subsystem 108 of GR system 110 more particularly comprises a static pose recognition module 114 and one or more other recognition modules 115. The other recognition modules may comprise, for example, respective recognition modules configured to recognize cursor gestures and dynamic gestures. The operation of illustrative embodiments of the GR system 110 of image processor 102 will be described in greater detail below in conjunction with FIGS. 2 through 6.

The recognition subsystem 108 receives inputs from additional subsystems 116, which may comprise one or more image processing subsystems configured to implement functional blocks associated with gesture recognition in the GR system 110, such as, for example, functional blocks for input frame acquisition, noise reduction, background estimation and removal, or other types of preprocessing. In some embodiments, the background estimation and removal block is implemented as a separate subsystem that is applied to an input image after a preprocessing block is applied to the image.

Exemplary noise reduction techniques suitable for use in the GR system 110 are described in PCT International Application PCT/US13/56937, filed on Aug. 28, 2013 and entitled “Image Processor With Edge-Preserving Noise Suppression Functionality,” which is commonly assigned herewith and incorporated by reference herein.

Exemplary background estimation and removal techniques suitable for use in the GR system 110 are described in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

It should be understood, however, that these particular functional blocks are exemplary only, and other embodiments of the invention can be configured using other arrangements of additional or alternative functional blocks.

In the FIG. 1 embodiment, the recognition subsystem 108 generates GR events for consumption by one or more of a set of GR applications 118. For example, the GR events may comprise information indicative of recognition of one or more particular gestures within one or more frames of the input images 111, such that a given GR application in the set of GR applications 118 can translate that information into a particular command or set of commands to be executed by that application. Accordingly, the recognition subsystem 108 recognizes within the image a gesture from a specified gesture vocabulary and generates a corresponding gesture pattern identifier (ID) and possibly additional related parameters for delivery to one or more of the applications 118. The configuration of such information is adapted in accordance with the specific needs of the application.

Additionally or alternatively, the GR system 110 may provide GR events or other information, possibly generated by one or more of the GR applications 118, as GR-based output 112. Such output may be provided to one or more of the processing devices 106. In other embodiments, at least a portion of set of GR applications 118 is implemented at least in part on one or more of the processing devices 106.

Portions of the GR system 110 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers for performing other functions associated with recognition of gestures within frames of an input image stream comprising the input images 111. Such processing layers may also be implemented in the form of respective subsystems of the GR system 110.

It should be noted, however, that embodiments of the invention are not limited to recognition of static or dynamic hand gestures, but can instead be adapted for use in a wide variety of other machine vision applications involving gesture recognition, and may comprise different numbers, types and arrangements of modules, subsystems, processing layers and associated functional blocks.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111. It is also possible that one or more of the applications 118 may be implemented on a different processing device than the subsystems 108 and 116, such as one of the processing devices 106.

Moreover, it is to be appreciated that the image processor 102 may itself comprise multiple distinct processing devices, such that different portions of the GR system 110 are implemented using two or more processing devices. The term “image processor” as used herein is intended to be broadly construed so as to encompass these and other arrangements.

The GR system 110 performs preprocessing operations on received input images 111 from one or more image sources. This received image data in the present embodiment is assumed to comprise raw image data received from a depth sensor, but other types of received image data may be processed in other embodiments. Such preprocessing operations may include noise reduction and background removal.

The raw image data received by the GR system 110 from the depth sensor may include a stream of frames comprising respective depth images, with each such depth image comprising a plurality of depth image pixels. For example, a given depth image D may be provided to the GR system 110 in the form of a matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111 from one or more image sources and provide processed images as part of GR-based output 112 to one or more image destinations. At least a subset of such image sources and image destinations may be implemented as least in part utilizing one or more of the processing devices 106.

Accordingly, at least a subset of the input images 111 may be provided to the image processor 102 over network 104 for processing from one or more of the processing devices 106. Similarly, processed images or other related GR-based output 112 may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize hand gestures, although the disclosed techniques can be adapted in a straightforward manner for use with other types of gesture recognition processes.

As noted above, the input images 111 may comprise respective depth images generated by a depth imager such as an SL camera or a ToF camera. Other types and arrangements of images may be received, processed and generated in other embodiments, including 2D images or combinations of 2D and 3D images.

The particular arrangement of subsystems, applications and other components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 114, 115, 116 and 118 of image processor 102. One possible example of image processing circuitry that may be used in one or more embodiments of the invention is an otherwise conventional graphics processor suitably reconfigured to perform functionality associated with one or more of the components 114, 115, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 112 from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. As a more particular example, a computer or mobile phone may be configured to incorporate the image processor 102 and possibly a given image source. Image sources utilized to provide input images 111 in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as the subsystems 108 and 116 and the GR applications 118. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

The operation of the GR system 110 of image processor 102 will now be described in greater detail with reference to the diagrams of FIGS. 2 through 6.

It is assumed in these embodiments that the input images 111 received in the image processor 102 from an image source comprise input depth images each referred to as an input frame. As indicated above, this source may comprise a depth imager such as an SL or ToF camera comprising a depth image sensor. Other types of image sensors including, for example, grayscale image sensors, color image sensors or infrared image sensors, may be used in other embodiments. A given image sensor typically provides image data in the form of one or more rectangular matrices of real or integer numbers corresponding to respective input image pixels. These matrices can contain per-pixel information such as depth values and corresponding amplitude or intensity values. Other per-pixel information such as color, phase and validity may additionally or alternatively be provided.

Referring now to FIG. 2, a process 200 performed by the static pose recognition module 114 in an illustrative embodiment is shown. The process is assumed to be applied to preprocessed image frames received from a preprocessing subsystem of the set of additional subsystems 116. The preprocessing subsystem performs noise reduction and background estimation and removal, using techniques such as those identified above. The image frames are received by the preprocessing system as raw image data from an image sensor of a depth imager such as a ToF camera or other type of ToF imager. The image sensor in this embodiment is assumed to comprise a variable frame rate image sensor, such as a ToF image sensor configured to operate at a variable frame rate. Accordingly, in the present embodiment, the static pose recognition module 114 can operate at a lower frame rate than other recognition modules 115, such as recognition modules configured to recognize cursor gestures and dynamic gestures. Other types of sources supporting variable or fixed frame rates can be used in other embodiments.

The process 200 includes the following steps:

1. Find hand region of interest (ROI);

2. Find hand skeleton;

3. Find hand main direction;

4. Find palm boundary;

5. Scan hand image;

6. Estimate hand features;

7. Normalize hand features; and

8. Recognition based on classification.

Each of the above-listed steps of the process 200 will be described in greater detail below. In other embodiments, certain steps may be combined with one another, or additional or alternative steps may be used.

Step 1. Find Hand ROI

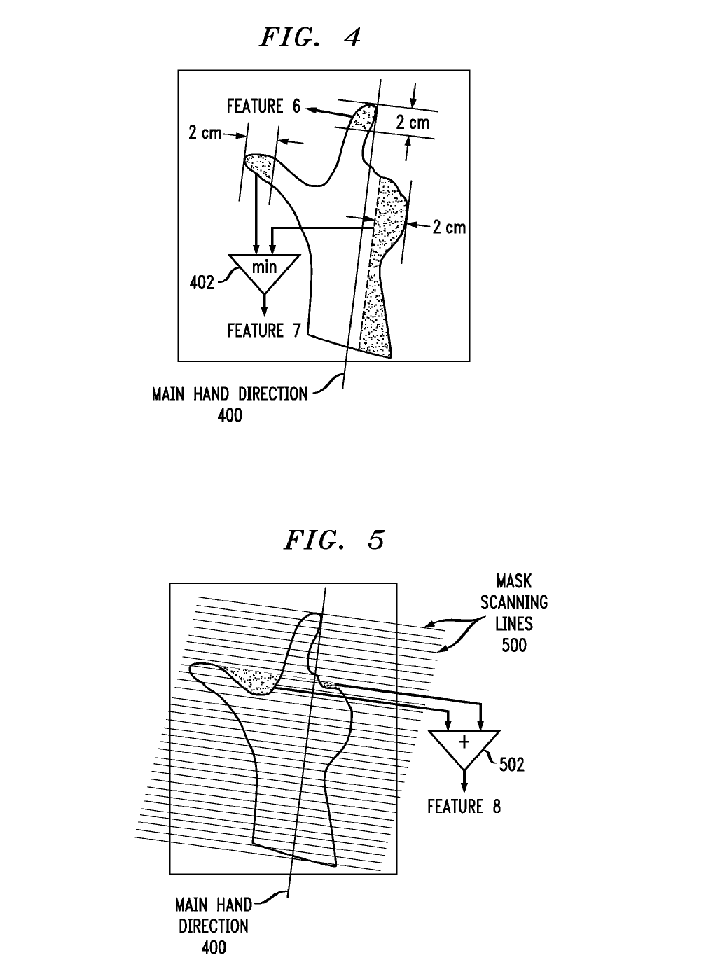

This step in the present embodiment more particularly involves defining an ROI mask for a hand in the input image. The ROI mask is implemented as a binary mask in the form of an image, also referred to herein as a “hand image,” in which pixels within the ROI are have a certain binary value, illustratively a logic 1 value, and pixels outside the ROI have the complementary binary value, illustratively a logic 0 value. The ROI corresponds to a hand within the input image, and is therefore also referred to herein as a hand ROI. An example of an ROI mask comprising a hand ROI can be seen in FIGS. 4 through 6 in the context of estimation of hand features. With reference to FIG. 5, the ROI mask is shown with 1-valued or “white” pixels identifying those pixels within the ROI, and 0-valued or “black” pixels identifying those pixels outside of the ROI. It can be seen that the hand ROI in example of FIGS. 4, 5 and 6 is in the form of a particular type of static hand pose, namely, a “fingergun” static hand pose. This is one of multiple static hand poses that may be recognized using the process 200.

As noted above, the input image in which the hand ROI is identified in Step 1 is assumed to be supplied by a ToF imager. Such a ToF imager typically comprises a light emitting diode (LED) light source that illuminates an imaged scene. Distance is measured based on the time difference between the emission of light onto the scene from the LED source and the receipt at the image sensor of corresponding light reflected back from objects in the scene. Using the speed of light, one can calculate the distance to a given point on an imaged object for a particular pixel as a function of the time difference between emitting the incident light and receiving the reflected light. More particularly, distance d to the given point can be computed as follows:

$$d = \frac{Tc}{2}$$

where T is the time difference between emitting the incident light and receiving the reflected light, c is the speed of light, and the constant factor 2 is due to the fact that the light passes through the distance twice, as incident light from the light source to the object and as reflected light from the object back to the image sensor. This distance is more generally referred to herein as a depth value.

The time difference between emitting and receiving light may be measured, for example, by using a periodic light signal, such as a sinusoidal light signal or a triangle wave light signal, and measuring the phase shift between the emitted periodic light signal and the reflected periodic signal received back at the image sensor.

Assuming the use of a sinusoidal light signal, the ToF imager can be configured, for example, to calculate a correlation function c(τ) between input reflected signal s(t) and output emitted signal g(t) shifted by predefined value τ, in accordance with the following equation:

$$c ( τ ) = {lim}_{T -> ∞} \frac{1}{T} {\int }_{T / 2}^{- T / 2} s ( t ) g ( t + τ ) d t .$$

In such an embodiment, the ToF imager is more particularly configured to utilize multiple phase images, corresponding to respective predefined phase shifts τₙ given by nπ/2, where n=0, . . . , 3. Accordingly, in order to compute depth and amplitude values for a given image pixel, the ToF imager obtains four correlation values (A₀, . . . A₃), where Aₙ=c(τₙ), and uses the following equations to calculate phase shift φ and amplitude α:

$$ϕ = arctg ( \frac{{A}_{3} - {A}_{1}}{{A}_{0} - {A}_{2}} ) , \\ a = \frac{1}{2} \sqrt{{( {A}_{3} - {A}_{1} )}^{2} + {( {A}_{0} - {A}_{2} )}^{2}} .$$

The phase images in this embodiment comprise respective sets of A₀, A₁, A₂ and A₃ correlation values computed for a set of image pixels. Using the phase shift φ, a depth value d can be calculated for a given image pixel as follows:

$$d = \frac{c}{4 πω} ϕ ,$$

where ω is the frequency of emitted signal and c is the speed of light. These computations are repeated to generate depth and amplitude values for other image pixels. The resulting raw image data is transferred from the image sensor to internal memory of the image processor 102 for preprocessing in the manner previously described.

The hand ROI can be identified in the preprocessed image using any of a variety of techniques. For example, it is possible to utilize the techniques disclosed in the above-cited Russian Patent Application No. 2013135506 to determine the hand ROI. Accordingly, the first step of the process 200 may be implemented in a preprocessing block of the GR system 110 rather than in the static pose recognition module 114.

As another example, the hand ROI can be determined using threshold logic applied to depth and amplitude values of the image. This can be more particularly implemented as follows:

1. If the amplitude values are known for respective pixels of the image, one can select only those pixels with amplitude values greater than some predefined threshold. This approach is applicable not only for images from ToF imagers, but also for images from other types of imagers, such as infrared imagers with active lighting. For both ToF imagers and infrared imagers with active lighting, the closer an object is to the imager, the higher the amplitude values of the corresponding image pixels, not taking into account reflecting materials. Accordingly, selecting only pixels with relatively high amplitude values allows one to preserve close objects from an imaged scene and to eliminate far objects from the imaged scene. It should be noted that for ToF imagers, pixels with lower amplitude values tend to have higher error in their corresponding depth values, and so removing pixels with low amplitude values additionally protects one from using incorrect depth information.

2. If the depth values are known for respective pixels of the image, one can select only those pixels with depth values falling between predefined minimum and maximum threshold depths Dmin and Dmax. These thresholds are set to appropriate distances between which the hand is expected to be located within the image.

3. Opening or closing morphological operations utilizing erosion and dilation operators can be applied to remove dots and holes as well as other spatial noise in the image.

One possible implementation of a threshold-based ROI determination technique using both amplitude and depth thresholds is as follows:

1. Set ROIᵢⱼ=0 for each i and j.

2. For each depth pixel dᵢⱼ set ROIᵢⱼ=1 if dᵢⱼ≧dₘᵢₙ and dᵢⱼ≦dₘₐₓ.

3. For each amplitude pixel aᵢⱼ set ROIᵢⱼ=1 if aᵢⱼ≧aₘᵢₙ.

4. Coherently apply an opening morphological operation comprising erosion followed by dilation to both ROI and its complement to remove dots and holes comprising connected regions of ones and zeros having area less than a minimum threshold area Aₘᵢₙ.

The output of the above-described ROI determination process is a binary ROI mask for the hand in the image. It can be in the form of an image having the same size as the input image, or a sub-image containing only those pixels that are part of the ROI. For further description below, it is assumed that the ROI mask is an image having the same size as the input image. As mentioned previously, the ROI mask is also referred to herein as a “hand image” and the ROI itself within the ROI mask is referred to as a “hand ROI.” The output may include additional information such as an average of the depth values for the pixels in the ROI. This average of depth values for the ROI pixels is denoted elsewhere herein as meanZ.

Step 2. Find Hand Skeleton

Two exemplary techniques are described below for determining the hand skeleton in the hand image. These techniques are examples of what are more generally referred to herein as skeletonization operations, and other types of skeletonization operations can be used in other embodiments. The first exemplary technique below, denoted Technique A, is less computationally complex but also less precise than the second exemplary technique, denoted Technique B.

Technique A

For each row of the hand image containing at least one pixel of the ROI, store the middle point between the outermost left and right 1 values in the row as the skeleton value for that row. The hand skeleton comprises the set of stored points for the respective rows.

Technique B

1. Apply a closing morphological operation, comprising dilation followed by erosion, to the hand image in order to maximally conglutinate the top four fingers, resulting in what is referred to herein as a “closed” hand image. Average typical distance between open fingers may be used as a pattern size for both dilation and erosion operations.

2. Calculate the distance transform of the closed hand image. More particularly, for each pixel in the ROI, calculate the minimal distance from the ROI boundaries using specified distance metrics, such as, for example, Euclidian or Manhattan distance metrics. Boundaries on a binary mask can be identified as pixels with value 1 having at least one neighbor pixel with value 0. The distance transform outside of the ROI is 0. The result of the distance transform calculation is a distance transform matrix DT=(dt)ᵢⱼ.

3. For each row i in which there is at least one ROI pixel, compute dtmaxᵢ=maxⱼdtᵢⱼ, and add to the skeleton all points (i, jₗ), . . . , (i, jₖᵢ) so that for all k=1 . . . ki, dtᵢⱼ_{ₖ}=dt maxᵢ. There can be more than a single local maximum in each row, so k can be greater than 1, but usually k=1.

For both Techniques A and B above, the resulting set of points is referred to herein as the hand skeleton SK={(iₗ, jₗ,), . . . , (iₖₛ, jₖₛ)}, where SK is the set of skeleton points, and the cardinality of SK is ks.

Step 3. Find Hand Main Direction

Exemplary techniques for finding the hand main direction described below include one of substeps 1a and 1b, each possibly combined with an optional substep 2.

1a. Approximate the set of points in the hand skeleton SK={(iₗ, jₗ), . . . , (iₖₛ, jₖₛ)} by a prediction line using Least Mean Squares (LMS). It should be noted that the main direction is usually vertical or near-vertical. Accordingly, the angle of variation of the prediction line from the vertical axis is usually smaller than 45 degrees. Using abscissa x and ordinate y to indicate respective row and column numbers, the main direction is given by a prediction line y=a*x+b that minimizes the following quadratic functional:

$${F}_{LMS} = {\sum }_{l = 1}^{ks} {( {ai}_{l} + b - {j}_{l} )}^{2} -> min .$$

It is possible to reverse the above definition of abscissa and ordinate so as to indicate respective column and row numbers, although the resulting prediction quality for main directions close to vertical is typically not as good.

The minimization above can be obtained by solving a system of two linear equations given by dF_{LMS}/da=0 and dF_{LMS}/db=0. This system of equations can be solved, for example, by computing a=(ks*Mxy−Mx*My)/(ks*Mxx−Mx*Mx), b=(My−Mx*a)/ks, where Mxy is a mixed raw moment for x,y, Mxx is a second-order raw moment for x, Myy is a second-order raw moment for y, Mx is a first-order raw moment for x, and My is a first-order raw moment for y. Other techniques can be used for solving the system of equations.

1b. Approximate the set of points in the hand skeleton SK={(iₗ, jₗ), . . . , (iₖₛ, jₖₛ)} by a prediction line using Principal Component Analysis (PCA). In this embodiment, PCA determines the cigcnvector corresponding to the largest eigenvalue of a covariance matrix CSK for a centered set SKc={(iₗ−i_{c}, jₗ−j_{c}), . . . , (iₗ−i_{c}, jₗ−j_{c})}, where i_{c} is a mean row value and j_{c} is a mean column value for the skeleton points. The line y=a*x+b is then determined as a=−2*mxy/(myy−mxx), b=j_{c}−i_{c}*a, where mxy is a mixed centered moment for x,y, mxx is a second-order centered moment for x, and myy is a second-order centered moment for y.

2. Compute the average deviation δ of distances between points of the skeleton and the prediction line found during substep 1a or 1b above, and remove all points of the skeleton with deviation greater than kδ, where k>0 (e.g., k=3). The removed points are also referred to herein as “outliers.” In order to simplify the calculations in this substep, Cartesian distance can be substituted by difference in y (i.e., column) coordinates of points. Substep 1a or 1b is then rerun to obtain a new estimate of the main direction. Substep 2 can be repeated until the set of points removed is empty.

After a given prediction line y=a*x+b is determined in substeps 1a or 1b above, the angle between the vertical axis and prediction line can be computed as angle=−arctg(a), where arctg denotes “arctangent.” This angle is an example of what is more generally referred to herein as a “main direction” of a hand. Accordingly, hand main direction can be characterized by the prediction line itself, by an angle made by the prediction line relative to the vertical axis, or by other information based on the prediction line.

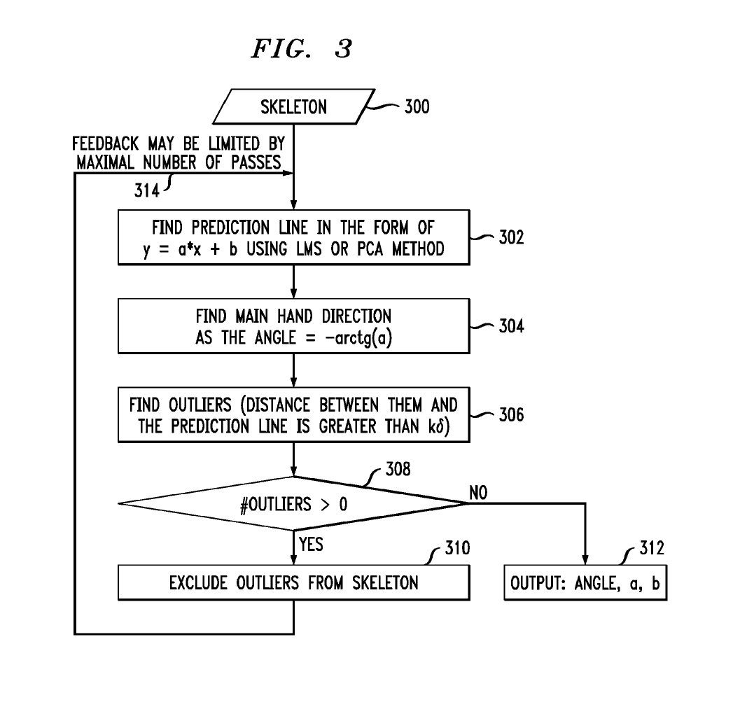

FIG. 3 illustrates an exemplary process of determining a main direction of a hand using the above-described substeps. The process starts with a skeleton 300 and includes steps 302 through 310. In step 302, the prediction line y=a*x+b is found using either the LMS or PCA method of respective substeps 1a or 1b. In step 304, the main direction of the hand is determined by computing the angle=−arctg(a). In step 306, any outliers are determined, as those points of the skeleton having a distance from the prediction line that is greater than greater than kδ. If the number of outliers is determined to be greater than zero in step 308, the outliers are excluded from the skeleton in step 310, and otherwise the process ends by outputting the angle and the prediction line parameters a and b as indicated in step 312. From step 310, a feedback line 314 returns the process to step 302 to recompute the prediction line with the outliers excluded from the skeleton as described in substep 2 above. Each time the process is repeated, additional outliers are excluded via step 310 and the prediction line is recomputed in step 302 using the resulting reduced set of skeleton points. The feedback may be limited to a specified maximum number of passes through the process.

Step 4. Find Palm Boundary

This step in the present embodiment more particularly involves defining the palm boundary and removing from the ROI any pixels below the palm boundary, leaving essentially only the palm and fingers in a modified hand image. Such a step advantageously eliminates, for example, any portions of the arm from the wrist to the elbow, as these portions can be highly variable due to the presence of items such as sleeves, wristwatches and bracelets, and in any event are typically not useful for static hand pose recognition.

Exemplary techniques that are suitable for use in implementing the palm boundary determination in the present embodiment are described in Russian Patent Application No. 2013134325, filed Jul. 22, 2013 and entitled “Gesture Recognition Method and Apparatus Based on Analysis of Multiple Candidate Boundaries,” which is commonly assigned herewith and incorporated by reference herein.

Alternative techniques can be used. For example, the palm boundary may be determined by taking into account that the typical length of the human hand is about 20-25 centimeters (cm), and removing from the ROI all pixels located farther than a 25 cm threshold distance from the uppermost fingertip along the previously-determined main direction of the hand. The uppermost fingertip can be identified as the uppermost point of the hand skeleton or as the uppermost 1 value in the binary ROI mask. The 25 cm threshold can be converted to a particular number of image pixels by using an average depth value determined for the pixels in the ROI as mentioned in conjunction with the description of Step 1 above.

Step 5. Scan Hand Image

This step in the present embodiment more particularly involves scanning the modified hand image resulting from Step 4. The scanning is performed line-by-line over lines that are perpendicular to the main direction line previously determined in Step 3. In conjunction with this step, the ROI mask is effectively modified so as to correspond to a vertically-oriented hand. This can be achieved by rotating the existing ROI mask by an angle α, where α is the angle between the main direction and the vertical axis as determined in Step 3, but such rotation is not computationally efficient for binary masks. Instead, perpendiculars to the main direction line are determined, and the hand image is scanned line-by-line along such perpendiculars. The latter approach may be considered a type of “virtual” rotation of the ROI mask, as opposed to a “real” rotation of the ROI mask by the angle α.

Two exemplary techniques are described below for determining a perpendicular to the main direction line, although other techniques can be used in other embodiments. The first exemplary technique below, denoted Technique A, is less computationally complex but also less precise than the second exemplary technique, denoted Technique B.

Technique A

Let y=A*x+B be a perpendicular to the main direction, assuming that the main direction cannot be a horizontal line. Let W be the width of the hand ROI, given by the difference between the column numbers of the leftmost and the rightmost ROI pixels. Then for each value of x=1 . . . W let y[x]=round(Ax+B), where round(x) denotes the closest integer value to x. The array of y[x], x=1 . . . W forms a discrete perpendicular to the main direction. Movement of the discrete perpendicular from the top image row to the bottom image row with a step size equal to 1 pixel between adjacent instances of the perpendicular will cover the entire image. However, the resulting ROI mask will have non-square pixels, such that correction coefficients (1/sin(α) and 1/cos(α)) are used to normalize the hand features in Step 7.

Technique B

This technique uses the angle α to calculate the perpendicular to the main direction, but scans using precise steps that are equal to 1 pixel both for movement along a given perpendicular to the main direction line and for movement along the main direction line from perpendicular to perpendicular. The coordinates can be rounded to nearest integer values or various types of interpolation (e.g., bilinear, bi-cubic, etc.) can be applied.

The following pseudocode example illustrates the technique in more detail. In this pseudocode example, the notation (jtip,itip) identifies the coordinates of the uppermost pixel in the hand ROI.

```
#define W 165 // Image width
#define H 120 // Image height
find_hand_direction(skeleton, a, b); // skeleton - input; a, b - output
float c = itip + a*jtip; // perpendicular line crossing point (jtip,itip):
y = − a*x + c
float alpha = arctg(a), sina = sin(alpha), cosa = cos (alpha);
float xx[165], yy[165];
for (int j=0; j<W; j++) { xx[j] = jtip + (j−W/2)*cosa; yy[j] = −a * xx [j]
+ c; }
cv::Mat mask; mask.create(H, W, CV_32F) ; mask = 0.0f;
#define INSIDE(x,y) (y>=1 && y<=H−2 && x>=1 && x<=W−2)
jleft = W−1; jright = 0;
int itop = H−1; ibottom = 0;
for (int i=0; i<H; i++)
{
    for (int j=0; j<W; j++)
    {
        if (INSIDE(xx[j],yy[j]) &&
roi.at<float>(int(yy[j]),int(xx[j]))>=0.5f)
        {
            jleft=min(jleft,j); jright=max(jright,j);
            itop=min(itop,i); ibottom=max(ibottom,i);
            mask.at<float>(i,j) = 1.0f;
        }
        xx[j] += sina; yy[j] += cosa;
    }
    if (yy[0]>II−1 && yy[W−1]>H−1) break;
}
```

Application of either of the above techniques results in an ROI mask that is effectively modified so as to correspond to a vertically-oriented hand. This modified ROI mask is also referred to herein as a vertically-oriented ROI mask. As mentioned previously, it is possible to obtain the modified ROI mask by performing a real rotation of the hand ROI by the angle α, although such a rotation would typically be less efficient than the exemplary virtual rotation techniques described above.

It should also be noted that at least a portion of the hand feature estimations described in Step 6 below may be performed in conjunction with the above-described scanning process. If in a given embodiment it is possible to calculate all of the desired hand features using a single pass of image scanning, one need not store the vertically-oriented ROI mask itself.

Step 6. Estimate Hand Features

This step generally involves estimating hand features using the vertically-oriented ROI mask described above. The estimated hand features, after any needed normalization in Step 7, are provided as input to classifiers configured to recognize particular static poses in Step 8. As mentioned previously, the estimation of the hand features can be performed as part of the image scanning of Step 5, in which case both Step 5 and Step 6 can be performed as a single combined step of the process 200. At least portions of Step 7 may also be implemented in such a combined step.

The use of a vertically-oriented ROI mask to estimate the hand features advantageously reduces the dimensionality of the operation and therefore improves its performance.

The hand features determined using the vertically-oriented ROI mask in Step 6 include at least a subset of the following features:

1. Square root of the hand area, where the hand area is defined as the number of ROI pixels with value 1.

2. Perimeter of the hand, given by the number of ROI pixels with value 1 which have at least one neighbor pixel with value 0.

3. Width of the hand, given by the difference between the column numbers of the leftmost and the rightmost ROI pixels.

4. Height of the hand, given by the difference between the row numbers of the uppermost and the lowermost ROI pixels.

5. Second-order centered moments for x and y coordinates of the ROI pixels.

6. Square root of the top finger area, where the top finger area is defined as the number of ROI pixels that are not farther than hₜₒₚ cm from the uppermost ROI pixel. An exemplary value for hₜₒₚ is hₜₒₚ=2, although other values could be used. The top finger area used in this feature is illustrated in FIG. 4 as the darkened portion of the tip of the pointing finger. The line 400 indicates the main direction line of the hand in the ROI mask.

7. Square root of the side finger area, where the side finger area is defined as the minimum of the number of ROI pixels that are not farther than h_{left} cm from the leftmost ROI pixel and the number of ROI pixels that are not farther than h_{right} cm from rightmost ROI pixel. Exemplary values for h_{left} and h_{right} are h_{left}=2 and h_{right}=2, although again other values could be used. The side finger area computation is performed by minimization element 402 in FIG. 4 using the darkened areas shown at left and right sides of the ROI mask.

8. Degree of non-convexity, given by the square root of the number of pixels with value 0 that are bordered by at least two ROI pixels with value 1 as determined while scanning the hand image along perpendiculars to the main direction as per Step 5. This is illustrated in FIG. 5, which shows a set of mask scanning lines 500 corresponding to respective perpendiculars of the main direction line 400 of the ROI mask. The identified 0-valued pixels are in two regions of the image, one in the trough between the thumb and forefinger and the other between a pair of knuckles of the hand, and the numbers of pixels in these two regions are combined by a summing element 502. The output of the summing element 502 is subject to a square root operation not specifically illustrated in the figure in order to generate the feature. The degree of non-convexity is equal to zero for all convex ROIs.

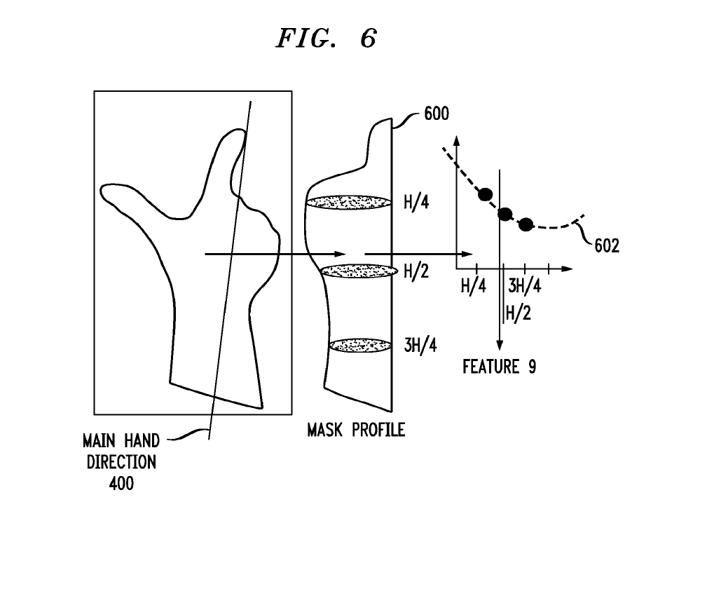

9. Degree of “egg-likeness.” Assume that the height of the hand is H, and that w₁=W_{1/4}, w₂=W_{1/2} and w₃=W_{3/4} are the widths of the hand at respective heights h₁=¼*H, h₂=½*H and h₃=¾*H. Using the three points (h₁, w₁), (h₂, w₂) and (h₃, w₃) in two-dimensional space, find a parabola of the form w(h)=a₁*h²+a₂*h+a₃ that goes through all three points. This feature is illustrated in FIG. 6, based on a mask profile 600 used to generate a parabola 602. The degree of “egg-likeness” is illustratively given by the curvature of the parabola as expressed by the first coefficient a₁.

The above-described hand features can all be calculated at relatively low complexity using one or at most two scanning passes through the ROI mask.

It should be noted that the above-described hand features are exemplary only, and additional or alternative hand features may be utilized to facilitate static pose recognition in other embodiments. For example, various functions of one or more of the above-described hand features or other related hand features may be used as additional or alternative hand features. Thus, functions other than square root may be used in conjunction with hand area, top finger area, side finger area or other features. Also, techniques other than those described above may be used to compute the features.

The particular number of features utilized in a given embodiment will typically depend on factors such as the number of different hand pose classes to be recognized, the shape of an average hand inside each class, and the recognition quality requirements. Techniques such as Monte-Carlo simulations or genetic search algorithms can be utilized to determine an optimal subset of the features for given levels of computational complexity and recognition quality.

As one example, a pointing gesture detector having only three distinct classes, corresponding to pointing forefinger, pointing forefinger with open thumb (“fingergun”), and all other static hand poses, respectively, can achieve an approximately 0.995 recognition rate using the subset of features 1, 2, 3, 6, 7 and 8.

Step 7. Normalize Hand Features

The previously-described steps result in an arrangement in which hand features are invariant to certain image transformations, such as rotation and movement. However, the hand features may also be made invariant to scaling by applying feature normalization as will now be described. It should again be noted that if Technique A is utilized for hand image scanning in Step 5, correction coefficients should be applied to take into account that the pixels of the scanned ROI mask are no longer square, although application of such correction coefficients does not significantly increase computational complexity.

The additional feature normalization can then be implemented as follows. If the average depth value for the ROI pixels is not available, linear features such as width, height and perimeter are normalized by dividing each such linear feature by the square root of the hand area, while second order features such as moments are normalized by dividing each such second order feature by the hand area itself. If the average depth value for the ROI pixels is available, linear features are instead multiplied by the average depth value and second order features are multiplied by the square of the average depth value.

The latter normalization based on the average depth value can be better understood by considering the correspondence between the size of a portion of an imaged object as captured in a given pixel and the size of that portion of the imaged object in real units (e.g., meters). This correspondence can be computed as pixel_size_in_meters=meanZ*tan(horzFOV/2)/(W/2), where meanZ denotes the average depth value as mentioned in conjunction with Step 1 above, W denotes hand width, and horzFOV denotes horizontal angle of field of view (e.g., 90 degrees). The normalized feature is then given by normalized_feature_in_meters=feature_in_pixels*pixel_size_in_meters. It is therefore apparent that linear features should be multiplied by a coefficient proportional to the average depth value, and that features of higher order should be multiplied by a coefficient proportional to the average depth value to that order, as in the normalization previously described.

Step 8. Recognition Based on Classification

In this step, classification techniques are applied to recognize static hand poses based on the normalized hand features from Step 7. Examples of static pose classes that may be utilized in a given embodiment include finger, palm with fingers, palm without fingers, hand edge, pinch, fist, fingergun and head. Each static pose class utilizes a corresponding classifier configured in accordance with a classification technique such as, for example, Gaussian Mixture Models (GMMs), Nearest Neighbor, Decision Trees, and Neural Networks. Additional details regarding the use of classifiers based on GMMs in the recognition of static hand poses can be found in the above-cited Russian Patent Application No. 2013134325.

The particular types and arrangements of processing blocks shown in the embodiments of FIGS. 2 and 3 are exemplary only, and additional or alternative blocks can be used in other embodiments. For example, blocks illustratively shown as being executed serially in the figures can be performed at least in part in parallel with one or more other blocks or in other pipelined configurations in other embodiments.

The illustrative embodiments provide significantly improved gesture recognition performance relative to conventional arrangements. For example, these embodiments provide computationally-efficient static pose recognition using estimated hand features that are substantially invariant to hand orientation within an image and in some cases also substantially invariant to scale and movement of the hand within an image. This avoids the need for complex hand image normalizations that would otherwise be required to deal with variations in hand orientation, scale and movement. Accordingly, the GR system performance is accelerated while ensuring high precision in the recognition process. The disclosed techniques can be applied to a wide range of different GR systems, using depth, grayscale, color infrared and other types of imagers which support a variable frame rate, as well as imagers which do not support a variable frame rate.

Different portions of the GR system 110 can be implemented in software, hardware, firmware or various combinations thereof. For example, software utilizing hardware accelerators may be used for some processing blocks while other blocks are implemented using combinations of hardware and firmware.

At least portions of the GR-based output 112 of GR system 110 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising steps of:
identifying a hand region of interest in at least one image;
performing a skeletonization operation on the hand region of interest;
determining a main direction of the hand region of interest utilizing a result of the skeletonization operation;
performing a scanning operation on the hand region of interest utilizing the determined main direction to estimate a plurality of hand features that are substantially invariant to hand orientation; and
recognizing a static pose of the hand region of interest based on the estimated hand features;
wherein the steps are implemented in an image processor comprising a processor coupled to a memory.

2. The method of claim 1 wherein the steps are implemented in a static pose recognition module of a gesture recognition system of the image processor.

3. The method of claim 2 wherein the static pose recognition module operates at a lower frame rate than at least one other recognition module of the gesture recognition system.

4. The method of claim 1 wherein identifying a hand region of interest comprises generating a hand image comprising a binary region of interest mask in which pixels within the hand region of interest all have a first binary value and pixels outside the hand region of interest all have a second binary value complementary to the first binary value.

5. The method of claim 1 wherein the result of the skeletonization operation comprises a hand skeleton comprising a set of skeleton points.

6. The method of claim 5 wherein performing a skeletonization operation on the hand region of interest comprises, for each of a plurality of rows of the hand region of interest, selecting a middle point between outermost left and right pixels of the hand region of interest as a skeleton point for that row.

7. The method of claim 5 wherein performing a skeletonization operation on the hand region of interest comprises:
applying a closing morphological operation to a hand image containing the hand region of interest to generate a closed hand image;
computing a distance transform for the closed hand image; and
selecting the skeleton points based on the distance transform.

8. The method of claim 1 wherein determining a main direction of the hand region of interest comprises:
determining a prediction line based on a set of skeleton points;
obtaining the main direction from the prediction line;
identifying skeleton points located more than a threshold distance from the prediction line;
eliminating the identified skeleton points from the set of the skeleton points to generate an updated set of skeleton points; and
repeating the determining, obtaining, identifying and eliminating for one or more additional iterations until a designated minimum number of identified skeleton points is reached or a designated maximum number of iterations is reached.

9. The method of claim 1 further comprising:
identifying a palm boundary of the hand region of interest; and
modifying the hand region of interest to exclude from the hand region of interest any pixels below the identified palm boundary.

10. The method of claim 1 wherein performing a scanning operation utilizing the determined main direction comprises:
determining a plurality of lines perpendicular to a line of the main direction; and
scanning the hand region of interest along the perpendicular lines.

11. The method of claim 1 wherein the hand features include one or more of the following hand features or functions thereof:
an area of the hand region of interest;
a perimeter of the hand region of interest;
a width of the hand region of interest; and
a height of the hand region of interest.

12. The method of claim 1 wherein the hand features include second-order centered moments or functions thereof for coordinates of pixels of the hand region of interest.

13. The method of claim 1 wherein the hand features include one or more of the following hand features or functions thereof:
a top finger area;
a side finger area; and
degree of non-convexity.

14. The method of claim 1 wherein the hand features include one or more coefficients of a parabola fit to points given by widths of the hand region of interest at respective specified heights of the hand region of interest.

15. A non-transitory computer-readable storage medium having computer program code embodied therein, wherein the computer program code when executed in the image processor causes the image processor to perform the method of claim 1.

16. An apparatus comprising:
an image processor comprising image processing circuitry and an associated memory;
wherein the image processor is configured to implement a gesture recognition system utilizing the image processing circuitry and the memory, the gesture recognition system comprising a static pose recognition module; and
wherein the static pose recognition module is configured to identify a hand region of interest in at least one image, to perform a skeletonization operation on the hand region of interest, to determine a main direction of the hand region of interest utilizing a result of the skeletonization operation, to perform a scanning operation on the hand region of interest utilizing the determined main direction to estimate a plurality of hand features that are substantially invariant to hand orientation, and to recognize a static pose of the hand region of interest based on the estimated hand features.

17. The apparatus of claim 16 wherein the static pose recognition module is configured to determine a main direction of the hand region of interest by determining a prediction line based on a set of skeleton points, obtaining the main direction from the prediction line, identifying skeleton points located more than a threshold distance from the prediction line, eliminating the identified skeleton points from the set of the skeleton points to generate an updated set of skeleton points, and repeating the determining, obtaining, identifying and eliminating for one or more additional iterations until a designated minimum number of identified skeleton points is reached or a designated maximum number of iterations is reached.

18. The apparatus of claim 16 wherein the static pose recognition module is configured to perform a scanning operation utilizing the determined main direction by determining a plurality of lines perpendicular to a line of the main direction and scanning the hand region of interest along the perpendicular lines.

19. An integrated circuit comprising the apparatus of claim 16.

20. An image processing system comprising the apparatus of claim 16.
